(19) United States
(12) Patent Application Publication
(10) Pub. No.: US 2015/0161704 A1
(43) Pub. Date: Jun. 11, 2015

(54) CROWDSOURCING RETAIL PRICE AND LOCATION METHOD AND SYSTEM

(71) Applicant: YAHOO!INC., Sunnyvale, CA (US)

(72) Inventor: Ronny Lempel, Zichron Yaakov (IL)

(73) Assignee: YAHOO!INC., Sunnyvale, CA (US)

(21) Appl. No.: 14/101,571

(22) Filed: Dec. 10, 2013

(51) Int. Cl. G06Q 30/06; G06Q 50/00

(52) U.S. Cl. CPC G06Q 30/0629; G06Q 50/01; G06Q 30/0639

(57) ABSTRACT

A crowdsourcing approach is used to collect from contributors, e.g., a large group of consumers, item pricing offered by the sellers from which the contributors have purchased the items. A contributor may provide item pricing information associated with a given store by uploading a receipt from the store, which receipt identifies the item(s) purchased by the contributor and a price for each item purchased, store information, e.g., store name, location, telephone number, etc. A database or other data store may be used to maintain contributor, store and item information. The stored information may identify which store is/are selling which item(s) and at what price(s). A shopping list may be generated, which includes information identifying one or more items and, for each item, the store at which the item(s) may be purchased at the lowest available price relative to other stores. By analyzing consumers' shopping habits, personalized target of ads and/or promotions can be achieved.

### FIELD OF THE DISCLOSURE

The present disclosure relates to enabling informed shopping, and more particularly to crowdsourcing retail price and location data for dissemination to the public.

### BACKGROUND

Consumers are interested in purchasing an item at the item's lowest available price. Of course, there are mitigating factors that result in the consumer not being able to obtain an item at its lowest price. For example, the seller, e.g., a brick-and-mortar vendor or store, offering the lowest price might be too far from the consumer's location. Another mitigating factor is that the consumer may not be aware of the item's pricing at various sellers. Sellers may provide advertisements about their products and prices; however, these advertisements might be part of a national or regional ad campaign that may not reflect an individual's store's product pricing. For example, a drug, grocery, etc. store chain might publish advertisements listing prices of some items that are being sold at their stores. These ad campaigns may not reflect each and every individual store's actual pricing for the item and/or the price of other items that the store has placed on sale. An individual store may be offering an item at a special price that is not published. Consequently, consumers might only become aware of a special price for an item where the consumers visit the store and happen on the item at the special price.

### SUMMARY

The present disclosure seeks to address failings pertaining to the transparent flow of retail pricing information and to provide a method and system for crowdsourcing retail pricing and locations. In accordance with one or more embodiments, a crowdsourcing approach is used to collect from contributors, e.g., a large group of consumers, item pricing offered by the sellers from which the contributors have purchased the items. In accordance with one or more such embodiments, a contributor may provide item pricing information associated with a given store by uploading a receipt from the store, which receipt identifies the item(s) purchased by the contributor and a price for each item purchased. Additionally, the receipt may include information identifying the store, e.g., store name, location, telephone number, etc. In accordance with one or more embodiments, a database or other data store may be used to maintain contributor, store and item information. The stored information may identify which business(s), store(s), vendor(s), etc. is/are selling which item(s) and at what price(s). By way of a non-limiting example, the store information may be used to compose a shopping basket, e.g., a shopping list, which comprises information identifying one or more items and, for each item, the business, store, vendor, etc., at which the item(s) may be purchased at the lowest available price. In accordance with one or more embodiments, the lowest available price for an item may be relative to the item's price offered by one or more other business(s), store(s), vendor(s), etc. Of course, other applications are possible using the information collected from the contributors. Consumers' shopping habits may be analyzed to provide personalized targeting of ads and/or promotions.

In accordance with one or more embodiments, a method is provided, the method comprising receiving, using at least one computing device, crowdsourced item pricing information, at least some of the crowdsourced item pricing information is extracted from a plurality of receipts received from a plurality of contributing users, each receipt of the plurality identifying a seller, at least one item purchased from the seller and a corresponding price of the item; maintaining, using the at least one computing device, a data store including the crowdsourced item pricing information comprising information for each of a plurality of sellers, item information for each of a plurality of items and user information for each of the plurality of contributing users; receiving, using the at least one computing device and from a requester, an item pricing request for one or more items; and providing a response, using the at least one computing device and the crowdsourced item pricing information, the response identifying, for each item of the one or more items, a seller from the plurality of sellers determined to offer the item at a lowest item price relative to other sellers of the plurality considered for the response and the seller's price for the item.

In accordance with one or more embodiments a system is provided, which system comprises at least one computing device comprising one or more processors to execute and memory to store instructions to receive crowdsourced item pricing information, at least some of the crowdsourced item pricing information is extracted from a plurality of receipts received from a plurality of contributing users, each receipt of the plurality identifying a seller, at least one item purchased from the seller and a corresponding price of the item; maintain a data store including the crowdsourced item pricing information comprising information for each of a plurality of sellers, item information for each of a plurality of items and user information for each of the plurality of contributing users; receive, from a requester, an item pricing request for one or more items; and provide a response, using the crowdsourced item pricing information, the response identifying, for each item of the one or more items, a seller from the plurality of sellers determined to offer the item at a lowest item price relative to other sellers of the plurality considered for the response and the seller's price for the item.

In accordance with yet another aspect of the disclosure, a computer readable non-transitory storage medium is provided, the medium for tangibly storing thereon computer readable instructions that when executed cause at least one processor to receive crowdsourced item pricing information, at least some of the crowdsourced item pricing information is extracted from a plurality of receipts received from a plurality of contributing users, each receipt of the plurality identifying a seller, at least one item purchased from the seller and a corresponding price of the item; maintain a data store including the crowdsourced item pricing information comprising information for each of a plurality of sellers, item information for each of a plurality of items and user information for each of the plurality of contributing users; receive, from a requester, an item pricing request for one or more items; and provide a response, using the crowdsourced item pricing information, the response identifying, for each item of the one or more items, a seller from the plurality of sellers determined to offer the item at a lowest item price relative to other sellers of the plurality considered for the response and the seller's price for the item.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides an example process flow in accordance with one or more embodiments of the present disclosure.

FIG. 2 provides an example of a paper receipt which may be used in accordance with one or more embodiments of the present disclosure.

FIG. 3 shows some items listed in the receipt shown in FIG. 2, information from which may be used in accordance with one or more embodiments of the present disclosure.

FIG. 4 provides an example of a request process flow for use in accordance with one or more embodiments of the present disclosure.

FIG. 5 illustrates some components that can be used in connection with one or more embodiments of the present disclosure.

FIG. 6 is a detailed block diagram illustrating an internal architecture of a computing device in accordance with one or more embodiments of the present disclosure.

### DETAILED DESCRIPTION

Subject matter will now be described more frilly hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The detailed description provided herein is not intended as an extensive or detailed discussion of known concepts, and as such, details that are known generally to those of ordinary skill in the relevant art may have been omitted or may be handled in summary fashion.

In accordance with one or more embodiments, a user may be any entity that makes use of any aspect described herein, a contributor may be a user that supplies one or more receipts and/or item pricing information. Unless otherwise indicated a requester may be a user or a contributor. In the foregoing discussion, the terms business, establishment, store, seller, vendor may be used interchangeably to refer to an entity that is selling an item, product, etc. Furthermore and while embodiments of the present disclosure are described with reference to a product or item, it is contemplated that embodiments of the present disclosure may also be used in connection with a service being offered by a business, establishment, store, seller, vendor, etc. By way of a non-limiting example, such a service might be one that has an identifiable equivalence across businesses, establishments, stores, sellers, vendors, etc., and such an equivalent service might be identified using a bar code and/or other identification mechanism now know or later developed to identify an equivalent service.

In general, the present disclosure includes a crowdsourcing retail price and location system, method and architecture. Embodiments of the present disclosure provide a mechanism for collecting seller's pricing data, including pricing data that is unpublished pricing data.

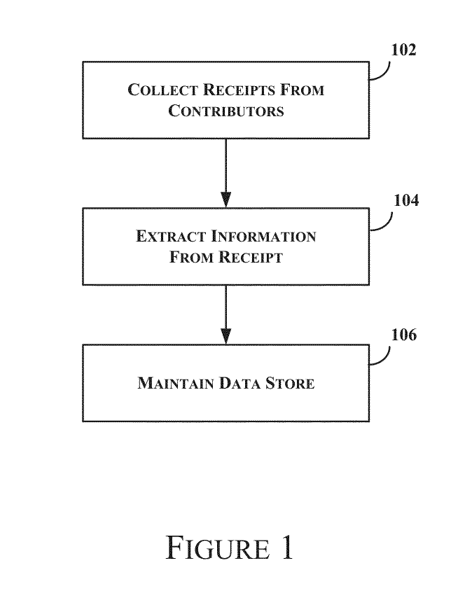

FIG. 1 provides an example process flow in accordance with one or more embodiments of the present disclosure. At step 102, a receipt is received. The receipt may be one of a number of receipts received from contributors. By way of some non-limiting examples, a user might scan, or photograph, a paper receipt and upload the scanned/photographed receipt, or the receipt might be an electronic receipt received from the business, store, seller, vendor, etc.

In the example provided in FIG. 1, pricing information is crowdsourced using a plurality of contributors providing shopping receipts. A contributor that supplies a receipt might be the purchaser of one or more items. Alternatively, a contributor might be another entity, e.g., the business/store/vendor that issued the receipt, e.g., the receipt issue might transmit an electronic copy of the receipt.

While embodiments of the present disclosure are discussed in connection with crowdsourcing receipts, a receipt need not be the only source of item pricing information. By way of a non-limiting example, any evidence of an item's pricing might be crowdsourced from any entity acting as a contributor. By way of a non-limiting example, item pricing might be received from a contributor in the form of a replica of an item's price tag and/or sticker; the replica might be a photograph, copy, scan, etc. of the item's sticker(s) and/or tag(s), which includes information about the item, including the item's price. The captured/received information may include the item's product code and/or description. Such a contribution might have an associated confidence level that is the same as or different from a confidence level associated with a receipt.

A smartphone might be used to capture and transmit the information that is collected and store in accordance with one or more embodiments.

In accordance with one or more embodiments, confidence in an item's price may be bolstered, or increased, where more than one contribution provides evidence of a given business' item pricing. Conversely, evidence showing that different prices for the same item and business may result in a decreased confidence level in the business' price for the item. Confidence in an item's price may reflect the temporal information associated with the pricing information. By way of some non-limiting examples, as an item's pricing information ages, the confidence level in the pricing information may be decreased; however, if more recent pricing information is received that shows the same pricing information, such recent pricing information may indicate a level of stability in the item's pricing information, which may result in a greater level of confidence in the older pricing information.

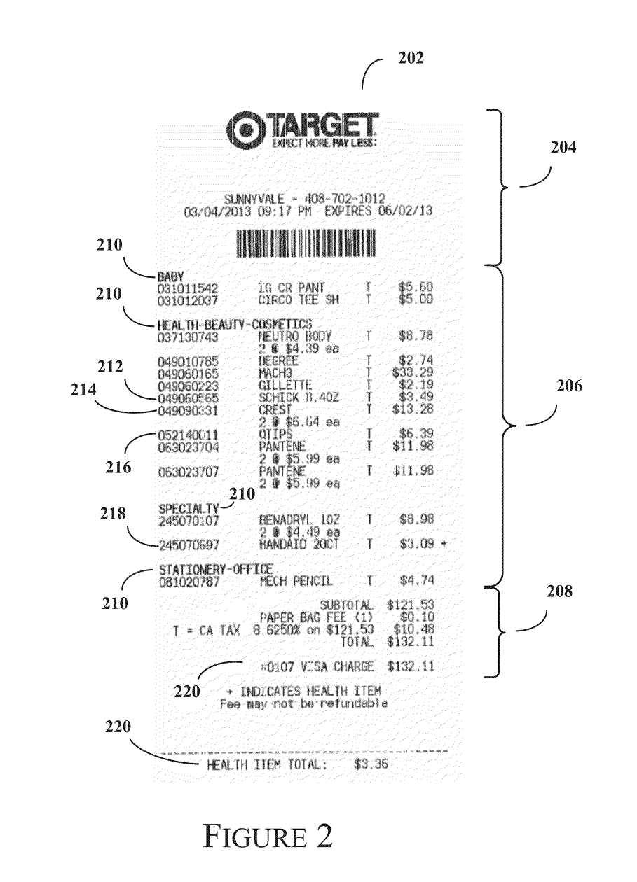

At step 104, information may be extracted from a received receipt. FIG. 2 provides an example of a receipt that might be received from a contributor. FIG. 2 provides an example of a paper receipt which may be used in accordance with one or more embodiments of the present disclosure. By way of a non-limiting example, receipt 202 might be scanned or photographed, uploaded and received. In the example of FIG. 2, receipt 202 provides information about the store and the items purchased at the store by a user. In accordance with one or more embodiments, the information provided by receipt 202 may be extracted and maintained in one or more databases and/or data stores.

In the example shown in FIG. 2, information about the store, temporal information, e.g., the date and time of the purchase, is provided in the first portion 204 of the receipt 202. Where the receipt does not identify the seller and/or does not provide some or all of the seller's information, e.g., the seller's location, the contributor might be asked to supply such information by entering the street address, city and state. Alternatively and where the user uploads the receipt while still at the seller's location, the user device's GPS may be used to identify the seller and/or the seller's location using the GPS coordinates.

Portion 206 provides a listing of the purchased items. Portion 208 of receipt 202 provides a summary of the amount(s) charged/paid, e.g., a subtotal, sales tax, miscellaneous fee and total amount.

It should be apparent that any type of format may be used for a contribution, e.g., a receipt, in connection with one or more embodiments of the present disclosure. By way of a non-limiting example and while receipts provided by different establishments may use different formats, any receipt may be analyzed to determine the format of the receipt and/or the location of the information that is to be extracted, e.g., the item(s) purchased, store information, etc., from the receipt. In accordance with one or more embodiments, a receipt template might be used to identify the location of the information to be extracted, where each establishment may have a corresponding receipt template. Indeed, while receipts may not uniformly conform to the same structure, many follow a few common templates since the market of check-out receipts is dominated by a handful of manufacturers.

Returning again to the paper receipt example provided in FIG. 2, portion 206 provides a listing of the items purchased by category 210, which may be extracted and stored. Portion 208 provides information identifying the way in which the items were purchased, e.g., cash, debit card, credit card, etc. In the example shown in FIG. 2, the amount of the purchase was charged to a credit card, which information may be extracted from the receipt and saved. By way of a non-limiting example, such information might be used to group product-level purchasing history over time, e.g., cash, debit and credit groupings.

Additionally, embodiments of the present disclosure allow for a contributor's spending to be tracked by category, e.g., product category, using a contributor's purchasing history collected from a contributor's uploaded receipts. Such tracking may be aggregated across a number of contributors. In accordance with one or more embodiments, a category may be defined at any level of detail. By way of a non-limiting example, a category may correspond to an industry segment or retail segment level, such as, for example, apparel, food and grocery, footwear, health & beauty, entertainment, jewelry, and the like. By way of another non-limiting example, spending may be categorized using such categories as business services, communications, communications, entertainment, merchandise and supplies, restaurant, transportation, travel, etc. By way of yet another non-limiting example, spending categories may include categories identified on uploaded receipts, such as the baby, health-beauty-cosmetics, specialty and stationery-office categories identified on the receipt shown in FIG. 2. As yet another non-limiting example, a category may be defined for a given product, e.g., shaving cream, which might be further broken down by manufacturer, e.g., Schick™ shaving cream, size, etc. In accordance with one or more embodiments, a category may be a system-defined category and/or a user-defined category, and each such category has an associated definition of one or more products and/or product categories belonging to the category. In accordance with one or more embodiments, spending for a given category may be provided for a given time frame, such as and without limitation daily, weekly, monthly, annually, and any multiple thereof.

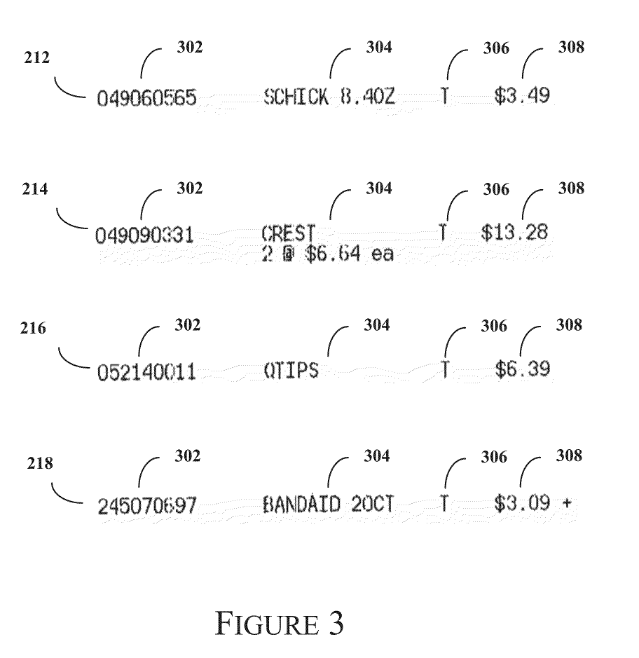

The items purchased and the price of each item purchased may be extracted from portion 206 of receipt 202. FIG. 3 shows items 212, 214, 216 and 218 included in the items listed in portion 206. Each of items 212, 214, 216 and 218 include item identification and pricing information. By way of a non-limiting example, item 212 includes item identification information comprising a product code 302, i.e., 049060565, for the item. In the example shown in FIG. 3, the product code is a numeric value; however, the product code may take a different form, such as and without limitation a barcode. A product code might be a universal product code (UPC), which may be a unique twelve digit number expressed as a number and/or barcode and is typically provided by the item's manufacturer. The product code might be provided by the business that is selling the item, in which case the product code might be the seller's stock keeping unit (SKU) number, or some other number or code. In accordance with embodiments of the present disclosure, the product code provided by a receipt may be normalized to the UPC assigned to the product. Where a product code other than the UPC is provided on the receipt, embodiments of the present disclosure may identify a mapping between the receipt's product identification, e.g., product number/code and/or description, and the item manufacturer's UPC for the item. The mapping might be provided by the seller or manufacturer, or might be generated using information identifying an association between the different identification information used for an item.

As shown in the example of FIG. 3, item identification information for item 212 also includes a description 304, which is in addition to product code 302. Description 304 of item 212 may be used in identifying a UPC of item 212. In the example shown, the description 304 of item 212 identifies the product's manufacturer and a size, e.g., in the example, size is a weight metric, 8.4 OZ″, one or both of which might be used to mine the product's UPC. The size information from description 304 may be used to identify a cost per ounce, which may be used to compare different prices for the item. By way of a non-limiting example, a cost per ounce determined by dividing the price 308 by the number of ounces specified by the size information included description 304 may be used in identifying a store that is selling the item, e.g., Schick™ shaving cream, at the lowest available cost per ounce. In other words, a store may be selling the same product in a smaller or larger container for a lower cost per ounce, which may be determined using the size and price information extracted from receipts, or other contributions, provided by users. Field 306 of item 212 indicates that the item 212 is a taxable item.

In accordance with one or more embodiments, the description 304 may be extracted and associated with the price 308 of the item 212 and the one or more product codes identified for the item 212. In addition and in accordance with one or more embodiments, the stored information extracted about item 212 may be associated with information extracted from portion 204 of receipt 202, e.g., the store, the time, the date etc., as well as information extracted from portion 208 of receipt 202.

As shown in FIG. 3, description 304 of item 214 indicates multiple units of the same item being purchased and indicates the cost per unit. Thus, the price 308 represents the combined price of the two units of the product purchased. In accordance with one or more embodiments, this information may be extracted and stored.

Item 216 of FIG. 3 provides an example of an item description 304 which does not include any size, quantity, count, etc. information.

Description 304 of item 218 shown in FIG. 3 provides an example of an item that packages, or otherwise contains or includes, multiple sub-items. The description 304 of item 218 indicates a count of the number of sub-items of the item purchased, e.g., 20 bandages. As with the size, e.g., weight, information provided in description 304 of 212, count information provided in description 304 of item 218 may be used to determine a cost per sub-item, which may be used in comparing prices for the same item but offering a different number of sub-items, e.g., two different items offered by the same manufacturer and differing only in the number of sub-items provided by the item.

Referring again to FIG. 2, receipt 202 provides an entry 220, which provides a total amount paid in the receipt for the health-related item(s) purchased. In the example shown in receipt 202, the amount listed by entry 220 corresponds to the amount paid, including tax, for item 218. In accordance with embodiments of the present disclosure, this information may be extracted, stored and accumulated for the contributing user. By way of a non-limiting example, an aggregate value might be available to a user and might be aggregated according for a given time frame, such as for a given year. By way of a further non-limiting example, such an aggregate might be used for purposes of household budget planning and/or tracking of aggregate household spending. As yet further non-limiting examples, such an aggregate might be used for tax return preparation purposes, reimbursement purposes, etc.

Embodiments of the present disclosure may maintain aggregate pricing information using any criteria and/or any level. By way of some non-limiting examples, product information may be used to generate an aggregate amount paid for prescriptions, for a given item or item type, item category, a given store, a store type or category, etc. By way of a further non-limiting example, an aggregate may be determined for any time period, e.g., week, month, year, range of time, etc. The stored information may be used to provide item level information, which item level information may be aggregated to provide various summaries and/or pricing trends. In accordance with one or more embodiments, an aggregation may aggregate pricing information across contributors and be made available to the users and/or the general public regardless whether or not they are contributor.

In accordance with one or more embodiments, item level information may be summarized by category, e.g., product, retail segment, business segment, etc. Similarly and in accordance with one or more embodiments, pricing trends may be determined for a given category or categories. By way of one non-limiting example, item level information might be aggregated across contributors for items belonging to a consumer electronics category, or a specific consumer electronics category such as and without limitation a televisions category, to identify a pricing trend which might be used in determining whether or not to make an item purchase.

Additionally and in accordance with one or more embodiments, a pricing trend, or pricing trends, reflecting an aggregation across contributors might be used to generate spending and/or consumption statistics for a given geographic area, such as and without limitation a metropolitan area, country, etc.

Referring again to FIG. 1, as shown in step 106, a store of data is maintained. By way of a non-limiting example, a data store may comprise one or more databases. In accordance with one or more embodiments, a backend database may comprise for each user, the item(s) purchased, when, where and for how much. In addition and for each item sold, the database may track where the item was sold, when it was sold and for how much, and for each seller, e.g., a store, establishment, etc., information stored in the database may be used to track the item(s) that the seller sells and each item's price over time.

By way of a non-limiting example, each time an item is sold, which event may be identified using a receipt, the database may be updated to include information from the sale, such as and without limitation, information about the user that purchased the item, such as and without limitation user identification information; information about the item purchased, such as and without limitation the item's product code, descriptive information and price; temporal information, such as and without limitation the date and time of the purchase; seller information, such as and without limitation seller identification information, which might include a seller's number or other identifier and geographic location.

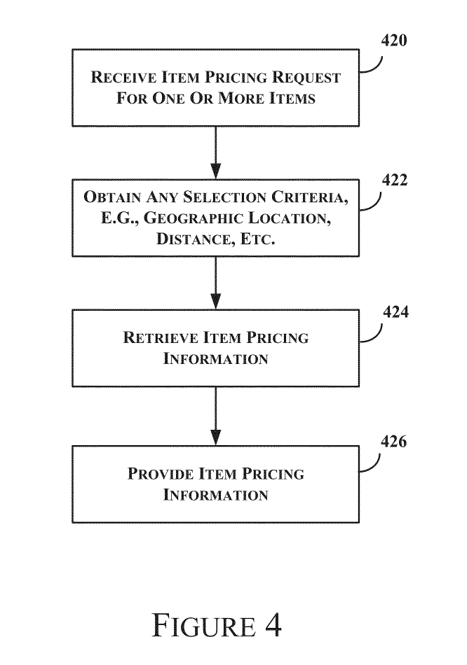

The information maintained in accordance with one or more embodiments of the present disclosure may be used to respond to a request from a user, such as and without limitation an item pricing request. FIG. 4 provides an example of a request process flow for use in accordance with one or more embodiments of the present disclosure.

At step 420 of FIG. 4, an item pricing request may be received from a requester, e.g. a user such as and without limitation an individual or other entity providing one or more receipts. By way of a non-limiting example, the item pricing request may identify one or more items and may comprise a request to identify a seller for each identified item. Selection criterion, or criteria, such as user-supplied selection criterion/criteria, system-supplied selection criterion/criteria, etc., if any, may be received, or retrieved, at step 422. By way of some non-limiting examples, a selection criterion might indicate a number of vendors, which might server to limit the number of vendors, to consider in a case that multiple items are identified in step 420. Where multiple selection criterion, are obtained, the criteria might be prioritized.

In accordance with one or more embodiments, a factor or criterion for selection may be a lowest-cost criterion, such that a seller identified in response to the request may be a seller selling the item at the lowest cost relative to any other seller selling the item. In accordance with one or more embodiments, additional criteria may be used in connection with the lowest-cost criterion, such as and limitation a distance or geographic location selection criterion. By way of a non-limiting example, a distance or a geographic area may be used to identify a seller, such as and without limitation that the location of the seller is within a certain geographic area or within a specified distance or radius of a given location. The geographic area may be determined based on the requester's current location, e.g., as indicated using a device enabled with a global positioning system (GPS) capability, another location associated with the requester, such as and without limitation the requester's home, work, etc. The geographic area may be determined based on the location of another seller, such as and without limitation a seller identified as selling one or more of the items identified for the request. The distance or radius information might be specified as a certain number of miles, such as and without limitation within a certain number of miles of a geographic location. The geographic cation may be a starting geographic location, a destination geographic location etc. By way of a further non-limiting example, both lowest-cost and distance, or geographic area, might be used to select a seller that satisfies the distance/geographic area criterion and has the lowest cost relative to other sellers that satisfy the distance/geographic area criterion.

By way of a non-limiting example, the request may comprise a request to identify a seller for more than one item, and a shopping list may be composed in response. The shopping list, which may also be referred to as a shopping basket or shopping cart, may identify each seller, e.g. by name and location, and the item(s) to be purchased at each seller, where each seller may be selected based on one or more factors, such as and without limitation item pricing relative to other sellers selling the item, the seller's geographic location relative to geographic location criterion, number of items identified for the seller relative to other sellers, etc. By way of a non-limiting example, a request might identify a shopping cart with multiple items and include criteria to split the requester's shopping list, or shopping cart, between no more than two sellers within five miles of the requester's current location, and the response may include the requester's shopping list by identified seller showing which items to purchase at which seller. In effect, embodiments of the present disclosure provide an ability to compare seller item pricing across a number of sellers using the receipts provided by contributors using a crowdsourcing approach, and to select one or more sellers of one or more items using selection criterion or a combination of various selection criteria, e.g., criterion/criteria obtained at step 422 of FIG. 2.

Where a shopping list comprises more than one seller, the shopping list might identify an order for visiting the multiple sellers. By way of a further non-limiting example, the ordering of the sellers on the list may be a recommended visitation order, such that the first seller is the seller recommended to be visited first, and so on. The ordering may be based on a desired origin geographic location and/or destination geographic location. To further illustrate and without limitation, the request may have an associated geographic location, such as a geographic location that the requester is, or would like to be, at or near when the requester starts shopping, finishes shopping or sometime during shopping.

As discussed herein, various trends may be determined. In accordance with one or more embodiments, information from shopping lists, or shopping carts or baskets, of a number of contributing users may be aggregated to identify a trend. By way of a non-limiting example, a total shopping list price comprising an aggregate of the price of item(s) in the shopping list may be aggregated across the contributing users' shopping lists and an average price per shopping list may be determined using the shopping lists' aggregated amount and the number of shopping lists. By way of another non-limiting example, such a shopping list average may be determined for a given time period, e.g., a holiday season, summertime, springtime, etc. By way of a further non-limiting example, spending trends might be determined using shopping receipts received from contributing users', such that various spending averages and/or spending trends may be determined for a given seller, geographic area, time period, season, etc.

At step 424, item pricing information is retrieved for the requested item(s). As discussed herein, the item pricing information might be provided in the form of a shopping list, which identifies a seller for each requested item, and the item's seller is identified to have the lowest cost for the item relative to any other sellers considered for the item. As discussed, the sellers may be selected based on such criteria as seller location relative to another location, e.g., the requester's location.

At step 426, the requested item pricing information is provided to the requester.

In accordance with one or more embodiments, a request, such as is received at step 420 of FIG. 4, might be made while the requester is at a store. By way of a non-limiting example, the requester might identify an item by scanning a product code for the item using the requester's mobile phone or other device, and request the system to identify whether the item's price at the current store is the lowest available price for the item. In other words, the requester may comparison shop while at one store to determine whether another store may be offering the same item at a lower price. By way of a further non-limiting example, the requester might indicate a desire to limit the search to a store within a certain distance of the current store.

In accordance with one or more embodiments, a requester may ask for notification when the price of a specific item drops below a certain price threshold within a given geographical region. In accordance with one or more embodiments, the notification might be made without a specific request from the requester. By way of some non-limiting examples, the system may monitor a contributor's purchases based on the contributor's receipt(s) to identify purchasing habits of the contributor, and use such information to alert the contributor that a price of an item previously purchased by the contributor has reached a certain level, e.g., is less than the price at which the contributor previously, e.g., most-recently, purchased the item. Such an alert may be provided when the new price falls below a certain threshold, e.g., is 5%, 10%, etc. below the price at which the contributor previously purchased the item.

In accordance with one or more embodiments, information collected from contributors' receipts may be used to track an item's price over time and/or within a certain geographical area, e.g., an upward or downward pricing trend. Price fluctuations of an item or set of items may be tracked using the information. By way of some non-limiting examples, the price fluctuations of an item or set of items at a specific vendor, or store, may be tracked over time.

In accordance with one or more embodiments, the information collected from contributors' receipts may be used to observe the distribution of locations, e.g., by number of buyers, where a certain item has been purchased over a given period of time and/or within a given geographical area. Such information might be used by the seller and/or manufacturer to target advertisements and/or promotions.

In accordance with one or more embodiments, a contributor's purchases may be organized at various levels or categories. By way of some non-limiting examples, a contributor's purchases might be organized at an industry segment level, retail segment level, seller level, item category level, and/or item level.

In accordance with one or more embodiments, the information maintained in the data store may be used to identify trends. By way of some non-limiting examples, the information may be analyzed to identify the best time, e.g., time of day, day of the week, week of the month, month of the year, to purchase an item. Such information may be used to alert users as to when, or when not, to purchase an item.

In accordance with one or more embodiments, the information maintained in the data store may be used to recommend items to users. By way of a non-limiting example, a recommendation may comprise a recommendation of one or more items that are commonly purchased with one or more items purchased by the user. By way of a further non-limiting example, the stored information may be analyzed to identify items that a user is likely to want. To illustrate further and without limitation, a user's purchase history may be used to identify other users with similar purchase histories, e.g., users making purchases similar to those of the user; the recommendations made to the user may include items purchased by the similar users but may or may not have been purchased previously by the user.

In accordance with one or more embodiments, a user may be a seller, product manufacturer, business, etc. that may make use of the stored information to gain knowledge about purchases made by contributors, e.g. what items have been purchased, where the items have been purchased, when and for what price. The stored information might be used for advertisement and/or promotions targeted for one or more contributors identified using the stored information. A targeted audience for advertisements and/or promotions may be identified using product purchasing information collected for all sellers, debit/credit card issuers, users, etc., and may be focused one or more specific contributors using product level, seller level, card issuer level etc. stored information. By way of some non-limiting examples, a cola manufacture might use the stored information to target those contributors who have purchased potato chips by giving the contributors a coupon for a six pack of cola; a baby shampoo manufacturer might use the stored information to identify contributors who have purchased diapers for a coupon for the manufacturer's baby shampoo. The stored information may be used to determine demographic information for some or all of the contributors, which demographic information might be used for advertisement and/or promotional targeting. By way of some non-limiting examples, product purchasing information might be used to identify contributors with children within a certain age range, identify contributors' income levels, etc. Since the stored information is gathered across sellers, manufacturers and/or debit/credit card issuers, the knowledge base, and/or consumer base, is not limited to a specific seller, manufacturer and/or card issuer.

In accordance with one or more embodiments, an item's price at a given seller may be monitored by analyzing more than one receipt from the seller, e.g., a threshold number, of receipts are received showing the same price being charged by the seller for the item. In so doing, a confidence level in the item price may be established in this manner, and/or a change in the price of an item may be established.

In accordance with one or more embodiments, the stored information might be used for comparison shopping between brick-and-mortar vendors, e.g., the vendors whose receipts are received in accordance with one or more embodiments described herein, and online vendors. By way of some non-limiting examples, embodiments of the present disclosure might use the stored information about a given item, e.g., the item's product description, product code, and pricing available at the local vendor(s) to comparison shop on the internet to identify whether the item might be available at a better price from an online vendor. The comparison shopping might take into account costs associated with purchasing the item from the online vendor, e.g., shipping costs, etc., versus costs associated with purchasing the item from local, brick-and-mortar vendor, e.g., transportation costs, etc.

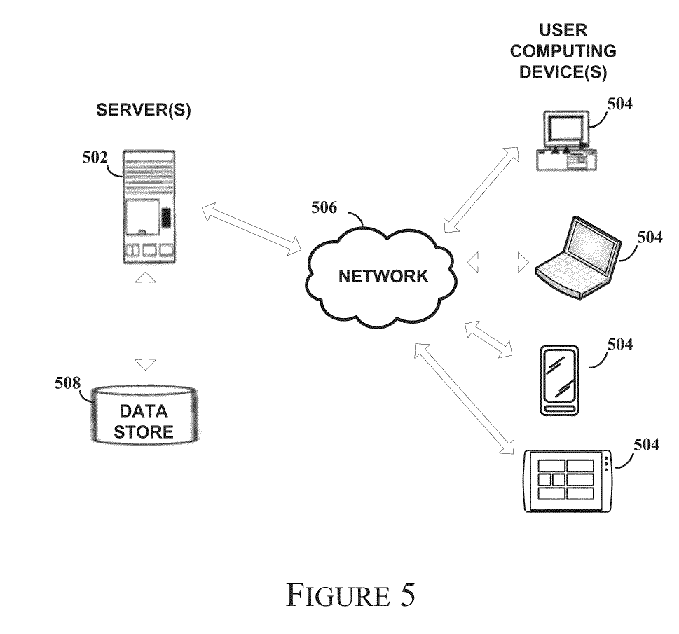

FIG. 5 illustrates some components that can be used in connection with one or more embodiments of the present disclosure. In accordance with one or more embodiments of the present disclosure, one or more computing devices, e.g., one or more servers, user devices 114 or other computing device, are configured to comprise functionality described herein. For example, a computing device 502 can be configured to execute program code, instructions, etc. to provide functionality in accordance with one or more embodiments of the present disclosure.

Computing device 502 can serve content, e.g., a shopping list, item pricing information, etc., to user computing devices 504 using a browser application via a network 506. Data store 508 can be used to store the data collected and maintained in accordance with one or more embodiments of the present disclosure, program code to configure a server 502 to execute the search engine 102, usefulness model generator 108 and/or usefulness predictor 112, configuration information, etc.

The user computing device 504, and/or user device 114, can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 502 and the user computing device 504 can include one or more processors, memory, a removable media reader, network interface, display and interface, and one or more input devices, e.g., keyboard, keypad, mouse, etc. and input device interface, for example. One skilled in the art will recognize that server 502 and user computing device 504 may be configured in many different ways and implemented using many different combinations of hardware, software, or firmware.

In accordance with one or more embodiments, a computing device 502 can make a user interface available to a user computing device 504 via the network 506. The user interface made available to the user computing device 504 can include content items, or identifiers (e.g., URLs) selected for the user interface in accordance with one or more embodiments of the present disclosure. In accordance with one or more embodiments, computing device 502 makes a user interface available to a user computing device 504 by communicating a definition of the user interface to the user computing device 504 via the network 506. The user interface definition can be specified using any of a number of languages, including without limitation a markup language such as Hypertext Markup Language, scripts, applets and the like. The user interface definition can be processed by an application executing on the user computing device 504, such as a browser application, to output the user interface on a display coupled, e.g., a display directly or indirectly connected, to the user computing device 504.

In an embodiment the network 506 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

As discussed, a network may couple devices so that communications may be exchanged, such as between a server computing device and a client computing device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4(G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.1b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

It should be apparent that embodiments of the present disclosure can be implemented in a client-server environment such as that shown in FIG. 5. Alternatively, embodiments of the present disclosure can be implemented with other environments. As one non-limiting example, a peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

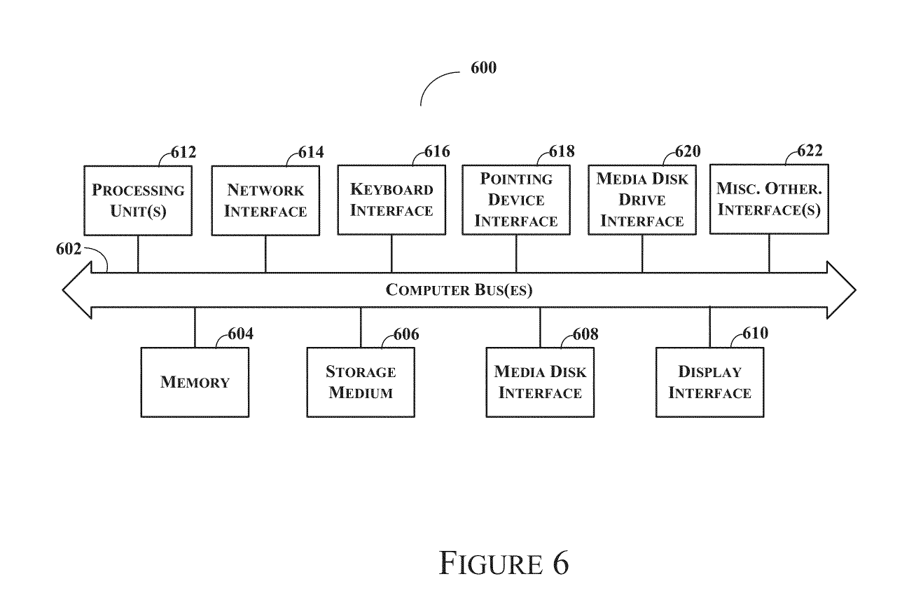

FIG. 6 is a detailed block diagram illustrating an internal architecture of a computing device, e.g., a computing device such as server 502 or user computing device 504, in accordance with one or more embodiments of the present disclosure. As shown in FIG. 6, internal architecture 600 includes one or more processing units, processors, or processing cores, (also referred to herein as CPUs) 612, which interface with at least one computer bus 602. Also interfacing with computer bus 602 are computer-readable medium, or media, 606, network interface 614, memory 604, e.g., random access memory (RAM), run-time transient memory, read only memory (ROM), etc., media disk drive interface 620 as an interface for a drive that can read and/or write to media including removable media such as floppy, CD-ROM, DVD, etc. media, display interface 610 as interface for a monitor or other display device, keyboard interface 616 as interface for a keyboard, pointing device interface 618 as an interface for a mouse or other pointing device, and miscellaneous other interfaces not shown individually, such as parallel and serial port interfaces, a universal serial bus (USB) interface, and the like.

Memory 604 interfaces with computer bus 602 so as to provide information stored in memory 604 to CPU 612 during execution of software programs such as an operating system, application programs, device drivers, and software modules that comprise program code, and/or computer-executable process steps, incorporating functionality described herein, e.g., one or more of process flows described herein. CPU 612 first loads computer-executable process steps from storage, e.g., memory 604, computer-readable storage medium/media 606, removable media drive, and/or other storage device. CPU 612 can then execute the stored process steps in order to execute the loaded computer-executable process steps. Stored data, e.g., data stored by a storage device, can be accessed by CPU 612 during the execution of computer-executable process steps.

Persistent storage, e.g., medium/media 606, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
receiving, using at least one computing device, crowdsourced item pricing information, at least some of the crowdsourced item pricing information is extracted from a plurality of receipts received from a plurality of contributing users, each receipt of the plurality identifying a seller, at least one item purchased from the seller and a corresponding price of the item;
maintaining, using the at least one computing device, a data store including the crowdsourced item pricing information comprising information for each of a plurality of sellers, item information for each of a plurality of items and user information for each of the plurality of contributing users;
receiving, using the at least one computing device and from a requester, an item pricing request for one or more items; and
providing a response, using the at least one computing device and the crowdsourced item pricing information, the response identifying, for each item of the one or more items, a seller from the plurality of sellers determined to offer the item at a lowest item price relative to other sellers of the plurality considered for the response and the seller's price for the item.

2. The method of claim 1, the item pricing request comprising a shopping cart identifying multiple items, the response splitting the items in the shopping cart among multiple sellers of the plurality, each of the multiple sellers determined to offer at least one of the multiple items at the lowest price relative to the other sellers of the plurality considered for the response, the response associating each one of the multiple items with one of the multiple sellers.

3. The method of claim 1, the sellers of the plurality of sellers considered for the response comprise those sellers located within a specific geographic area, such that, for each item of the one or more items, the seller from the plurality of sellers determined to be located within the geographic area and to offer the item at the lowest price relative to other sellers of the plurality of sellers located in the geographic area.

4. The method of claim 3, the geographic area is determined using a geographic location of a seller identified for the response.

5. The method of claim 3, the geographic area is determined using the requester's geographic location.

6. The method of claim 1, the crowdsourcing item pricing information is used to identify item purchasing histories across multiple sellers of the plurality of sellers for at least one contributing user of the plurality of contributing users.

7. The method of claim 1, the item purchasing histories of multiple ones of the contributing users of the plurality are identified and used for at least one of targeted advertising and targeted promotion.

8. The method of claim 1, for at least one of the one or more items, the request identifies a seller and the request comprises a request to determine whether the identified seller is offering the item at the lowest price relative to other sellers of the plurality located within a geographic area determined using the requester's current geographic location.

9. The method of claim 1, the crowdsourcing item pricing information is used to generate an item recommendation for at least one contributing user of the plurality, the item recommendation comprising at least one item purchased by one or more other contributing users of the plurality determined to be similar to the at least one contributing user using the crowdsourcing item pricing information.

10. The method of claim 1, the request is a request to alert the requester if a price of an item of the one or more items falls below a specified price, the method further comprising:
providing, using the at least one computing device, a notification to the requester when the item of the one or more items falls below the specific price.

11. The method of claim 1, the response identifying a number of sellers that is based on a selection criterion limiting the number of sellers selected for the response.

12. The method of claim 1, the crowdsourcing item pricing information is used to target at least one contributing user for at least one of one or more advertisements and one or more promotions.

13. The method of claim 1, the method further comprising:
identifying, using the at least one computing device, at least one trend for a contributing user of the plurality of contributing users using crowdsourcing item pricing information provided by the contributing user.

14. The method of claim 13, the at least one trend comprising one or more of the contributing user's spending relative to one or more of at least one item of the plurality of items, at least one category and at least one seller of the plurality of sellers.

15. The method of claim 1, the method further comprising:
identifying, using the at least one computing device, at least one trend using crowdsourcing item pricing information aggregated across more than one contributing user of the plurality of contributing users.

16. The method of claim 15, the at least one trend comprising a price of an item over a given time period for at least one seller of the plurality of sellers.

17. The method of claim 16, the at least one seller is within a geographic area.

18. The method of claim 15, the at least one trend comprising a pricing trend aggregated for at least one category and across more than one contributing user of the plurality of contributing users.

19. The method of claim 15, the at least one trend comprising a spending average aggregated across more than one contributing user of the plurality of contributing users.

20. The method of claim 19, the spending average aggregated across more than one contributing user of the plurality of contributing users is for a given period of time.

21. The method of claim 19, the spending average comprises an average shopping list total price determined by aggregating total prices of shopping lists of the more than one contributing user of the plurality of contributing users.

22. The method of claim 19, the spending average comprises an average spending determined by aggregating total amounts spent from receipts of the plurality of receipts received from the more than one contributing user of the plurality of contributing users.

23. A system comprising:
at least one computing device comprising one or more processors to execute and memory to store instructions to:
receive crowdsourced item pricing information, at least some of the crowdsourced item pricing information is extracted from a plurality of receipts received from a plurality of contributing users, each receipt of the plurality identifying a seller, at least one item purchased from the seller and a corresponding price of the item;
maintain a data store including the crowdsourced item pricing information comprising information for each of a plurality of sellers, item information for each of a plurality of items and user information for each of the plurality of contributing users;
receive, from a requester, an item pricing request for one or more items; and
provide a response, using the crowdsourced item pricing information, the response identifying, for each item of the one or more items, a seller from the plurality of sellers determined to offer the item at a lowest item price relative to other sellers of the plurality considered for the response and the seller's price for the item.

24. The system of claim 23, the request comprising a shopping cart identifying multiple items, the response splitting the items in the shopping cart among multiple sellers of the plurality, each of the multiple sellers determined to offer at least one of the multiple items at the lowest price relative to the other sellers of the plurality considered for the response, the response associating each one of the multiple items with one of the multiple sellers.

25. The system of claim 23, the sellers of the plurality of sellers considered for the response comprise those sellers located within a specific geographic area, such that, for each item of the one or more items, the seller from the plurality of sellers determined to be located within the geographic area and to offer the item at the lowest price relative to other sellers of the plurality of sellers located in the geographic area.

26. The system of claim 25, the geographic area is determined using a geographic location of a seller identified for the response.

27. The system of claim 25, the geographic area is determined using the requester's geographic location.

28. The system of claim 23, the crowdsourcing item pricing information is used to identify item purchasing histories across multiple sellers of the plurality of sellers for at least one contributing user of the plurality of contributing users.

29. The system of claim 23, the item purchasing histories of multiple ones of the contributing users of the plurality are identified and used for at least one of targeted advertising and targeted promotion.

30. The system of claim 23, for at least one of the one or more items, the request identifies a seller and the request comprises a request to determine whether the identified seller is offering the item at the lowest price relative to other sellers of the plurality located within a geographic area determined using the requester's current geographic location.

31. The system of claim 23, the crowdsourcing item pricing information is used to generate an item recommendation for at least one contributing user of the plurality, the item recommendation comprising at least one item purchased by one or more other contributing users of the plurality determined to be similar to the at least one contributing user using the crowdsourcing item pricing information.

32. The system of claim 23, the request is a request to alert the requester if a price of an item of the one or more items falls below a specified price, the instructions further comprising instructions to:
provide a notification to the requester when the item of the one or more items falls below the specific price.

33. The system of claim 23, the response identifying a number of sellers that is based on a selection criterion limiting the number of sellers selected for the response.

34. The system of claim 23, the crowdsourcing item pricing information is used to target at least one contributing user for at least one of one or more advertisements and one or more promotions.

35. The system of claim 23, the instructions further comprising instructions to:
identify at least one trend for a contributing user of the plurality of contributing users using crowdsourcing item pricing information provided by the contributing user.

36. The system of claim 35, the at least one trend comprising one or more of the contributing user's spending relative to one or more of at least one item of the plurality of items, at least one category and at least one seller of the plurality of sellers.

37. The system of claim 23, the instructions further comprising instructions to:
identify at least one trend using crowdsourcing item pricing information aggregated across more than one contributing user of the plurality of contributing users.

38. The system of claim 37, the at least one trend comprising a price of an item over a given time period for at least one seller of the plurality of sellers.

39. The system of claim 38, the at least one seller is within a geographic area.

40. The system of claim 37, the at least one trend comprising a pricing trend aggregated for at least one category and across more than one contributing user of the plurality of contributing users.

41. The system of claim 37, the at least one trend comprising a spending average aggregated across more than one contributing user of the plurality of contributing users.

42. The system of claim 41, the spending average aggregated across more than one contributing user of the plurality of contributing users is for a given period of time.

43. The system of claim 41, the spending average comprises an average shopping list total price determined by aggregating total prices of shopping lists of the more than one contributing user of the plurality of contributing users.

44. The system of claim 41, the spending average comprises an average spending determined by aggregating total amounts spent from receipts of the plurality of receipts received from the more than one contributing user of the plurality of contributing users.

45. A computer readable non-transitory storage medium for tangibly storing thereon computer readable instructions that when executed cause at least one processor to:
receive crowdsourced item pricing information, at least some of the crowdsourced item pricing information is extracted from a plurality of receipts received from a plurality of contributing users, each receipt of the plurality identifying a seller, at least one item purchased from the seller and a corresponding price of the item;
maintain a data store including the crowdsourced item pricing information comprising information for each of a plurality of sellers, item information for each of a plurality of items and user information for each of the plurality of contributing users;
receive, from a requester, an item pricing request for one or more items; and
provide a response, using the crowdsourced item pricing information, the response identifying, for each item of the one or more items, a seller from the plurality of sellers determined to offer the item at a lowest item price relative to other sellers of the plurality considered for the response and the seller's price for the item.

46. The computer readable non-transitory storage medium of claim 45, the request comprising a shopping cart identifying multiple items, the response splitting the items in the shopping cart among multiple sellers of the plurality, each of the multiple sellers determined to offer at least one of the multiple items at the lowest price relative to the other sellers of the plurality considered for the response, the response associating each one of the multiple items with one of the multiple sellers.

47. The computer readable non-transitory storage medium of claim 45, the sellers of the plurality of sellers considered for the response comprise those sellers located within a specific geographic area, such that, for each item of the one or more items, the seller from the plurality of sellers determined to be located within the geographic area and to offer the item at the lowest price relative to other sellers of the plurality of sellers located in the geographic area.

48. The computer readable non-transitory storage medium of claim 47, the geographic area is determined using a geographic location of a seller identified for the response.

49. The computer readable non-transitory storage medium of claim 47, the geographic area is determined using the requester's geographic location.

50. The computer readable non-transitory storage medium of claim 45, the crowdsourcing item pricing information is used to identify item purchasing histories across multiple sellers of the plurality of sellers for at least one contributing user of the plurality of contributing users.

51. The computer readable non-transitory storage medium of claim 45, the item purchasing histories of multiple ones of the contributing users of the plurality are identified and used for at least one of targeted advertising and targeted promotion.

52. The computer readable non-transitory storage medium of claim 45, for at least one of the one or more items, the request identifies a seller and the request comprises a request to determine whether the identified seller is offering the item at the lowest price relative to other sellers of the plurality located within a geographic area determined using the requester's current geographic location.

53. The computer readable non-transitory storage medium of claim 45, the crowdsourcing item pricing information is used to generate an item recommendation for at least one contributing user of the plurality, the item recommendation comprising at least one item purchased by one or more other contributing users of the plurality determined to be similar to the at least one contributing user using the crowdsourcing item pricing information.

54. The computer readable non-transitory storage medium of claim 45, the request is a request to alert the requester if a price of an item of the one or more items falls below a specified price, the instructions further comprising instructions to:
provide a notification to the requester when the item of the one or more items falls below the specific price.

55. The computer readable non-transitory storage medium of claim 45, the response identifying a number of sellers that is based on a selection criterion limiting the number of sellers selected for the response.

56. The computer readable non-transitory storage medium of claim 45, the crowdsourcing item pricing information is used to target at least one contributing user for at least one of one or more advertisements and one or more promotions.

57. The computer readable non-transitory storage medium of claim 45, the instructions further comprising instructions to:
identify at least one trend for a contributing user of the plurality of contributing users using crowdsourcing item pricing information provided by the contributing user.

58. The computer readable non-transitory storage medium of claim 57, the at least one trend comprising one or more of the contributing user's spending relative to one or more of at least one item of the plurality of items, at least one category and at least one seller of the plurality of sellers.

59. The computer readable non-transitory storage medium of claim 45, the instructions further comprising instructions to:
identify at least one trend using crowdsourcing item pricing information aggregated across more than one contributing user of the plurality of contributing users.

60. The computer readable non-transitory storage medium of claim 59, the at least one trend comprising a price of an item over a given time period for at least one seller of the plurality of sellers.

61. The computer readable non-transitory storage medium of claim 60, the at least one seller is within a geographic area.

62. The computer readable non-transitory storage medium of claim 59, the at least one trend comprising a pricing trend aggregated for at least one category and across more than one contributing user of the plurality of contributing users.

63. The computer readable non-transitory storage medium of claim 59, the at least one trend comprising a spending average aggregated across more than one contributing user of the plurality of contributing users.

64. The computer readable non-transitory storage medium of claim 63, the spending average aggregated across more than one contributing user of the plurality of contributing users is for a given period of time.

65. The computer readable non-transitory storage medium of claim 63, the spending average comprises an average shopping list total price determined by aggregating total prices of shopping lists of the more than one contributing user of the plurality of contributing users.

66. The computer readable non-transitory storage medium of claim 63, the spending average comprises an average spending determined by aggregating total amounts spent from receipts of the plurality of receipts received from the more than one contributing user of the plurality of contributing users.
